(19) United States
(12) Patent Application Publication
(10) Pub. No.: US 2025/0178788 A1
(43) Pub. Date: Jun. 5, 2025

(54) BEVERAGE CONTAINER WITH COMPARTMENT FOR BATTERY POWERED STRING LIGHTS

(71) Applicant: Hogg Outfitters, LLC, Edison, NJ (US)

(72) Inventor: Irene MAVRIANOS, Houston, TX (US)

(73) Assignee: Hogg Outfitters, LLC, Edison, NJ (US)

(21) Appl. No.: 18/529,165

(22) Filed: Dec. 5, 2023

(51) Int. Cl. B65D 25/20; B65D 23/10; B65D 23/14; B65D 43/02; B65D 81/38; F21S 9/02

(52) U.S. Cl. CPC B65D 25/20; B65D 23/104; B65D 23/14; B65D 43/0229; B65D 81/3869; F21S 9/02; B65D 2203/00

(57) ABSTRACT

The present invention provides for a beverage container with a storage compartment in the base of the beverage container to store string lights and to hold a battery connected to the string lights and having an opening in a portion of the storage compartment through which the string lights may extend and be wrapped around the beverage container for decoration. The beverage container can include a container body with a first portion and a second portion. The first portion of the container body can include a beverage holding chamber. The second portion of the container body can include the storage compartment. The first portion (e.g., the beverage holding chamber) and the second portion (e.g., storage compartment) of the container body can be separated by an interior wall in the container body. The beverage container can include a removable bottom closure that can be disengaged (e.g., removed) or engaged (e.g., attached) to the second portion of the container body.

### FIELD OF THE INVENTION

The present invention relates to a beverage container with a closeable storage compartment, including a structure for holding a battery, string lights connected to the battery and an opening in a portion of a wall of the storage compartment to enable the string lights to pass therethrough while still being connected to the battery when the compartment is closed.

### BACKGROUND

Beverage containers, such as tumblers, are growingly increasingly popular among consumers. For example, some consumers enjoy using beverage containers as a way to reduce use of disposable cups. Some consumers enjoy using beverage containers to keep their hot beverages hot. Some beverage containers come with additional features that improve their utility. For example, some beverage containers come with lids that help protect against spills.

### SUMMARY

Various aspects of the present invention relate to a beverage container (e.g., a tumbler) with a storage compartment for an ornamental decoration. In one aspect of the present invention, the storage compartment can include a battery holding structure with a battery within the battery holding structure and a battery powered ornamental decoration (e.g., string light) connected or connectable to the battery. In some instances, the ornamental decoration is not battery powered. Other ornamental decorations (e.g., music makers, ribbons, labels, strings, banners) and combinations of ornamental decorations can also be implemented, and the principles of the present invention are not limited to a particular ornamental decoration or a particular combination of ornamental decorations.

In one aspect of the present invention, the beverage container has a first portion defining a beverage holding chamber and a second portion defining a storage compartment that enables storage of an ornamental decoration. For example, the storage compartment can enable storage of a battery and string lights powered by the battery. The storage compartment can include a battery holding structure for the battery. The battery holding structure can be capable of holding the battery and be connected to the string lights. The beverage container can include an opening in a wall of the storage compartment, through which the string lights can extend while connected to the battery.

A removable bottom closure can be engaged (e.g., attached) and disengaged (e.g., removed) from the second portion, facilitating access to the storage compartment (e.g., to replace the battery, to access the string lights). In some instances, the battery holding structure can be attached to or included with the removable bottom closure. The removable bottom closure can be removed from the second portion to provide access to the battery holding structure attached to the removable bottom closure. The battery holding structure can be contained in the storage compartment when the removable bottom closure is attached to the second portion. In some instances, the string lights, or other ornamental decoration, can be fixedly attached or removably attached to the battery holding structure. Other configurations are possible, and the principles of the present invention are not limited to a particular configuration.

In one aspect of the present invention, the battery holding structure can be attached to a wall of the storage compartment, such as an internal wall separating the beverage holding chamber (e.g., first portion) of the beverage container and the storage compartment (e.g., second portion) of the beverage container. The battery holding structure can be accessed by removing the removable bottom closure from the storage compartment of the beverage container and opening the storage compartment in the beverage container. In some instances, the battery holding structure can be included in a battery enclosure within the storage compartment. In some instances, the battery holding structure can be attached to an inner portion of the removable bottom closure such that, when the removable bottom closure is attached to the second portion of the beverage container, closing the second portion of the beverage container, the battery holding structure is positioned within the storage compartment. Other configurations and positions for the battery holding structure are possible, and the principles of the present invention are not limited to a particular configuration or particular position.

In one aspect of the present invention, the beverage container has a container body that includes the first portion, which includes the beverage holding chamber, and the second portion, which includes the storage compartment. The container body can include an outer wall of the beverage container. The outer wall of the beverage container can also be the outer wall of the first portion and the outer wall of the second portion. In some instances, the outer wall can include an attaching structure (e.g., clip, fastener, clasp, hook and loop fastener or other attachment mechanism) to which at least a portion of an ornamental decoration (e.g., string lights) can be attached (e.g., engaged).

The container body can include an internal wall (e.g., divider wall) located within the beverage container. The internal wall can separate the first portion of the beverage container from the second portion of the beverage container. In this way, the beverage holding chamber is separated from the storage compartment. The container body can have an open upper end through which liquid can be poured into the beverage holding chamber and liquid can be drank from the beverage holding chamber. The container body can have a closed lower end on which the beverage container can be set down. The closed lower end can include the removable bottom closure. Other configurations for the container body are possible, and the principles of the present invention are not limited to a particular configuration.

In one aspect of the present invention, the storage compartment has a closed upper end and an open lower end that can be closed by the removable bottom closure. The closed upper end can be at least a part of the internal wall within the beverage container. The open lower end can be opened to provide access to the battery holding structure and the ornamental decoration within the storage compartment. The open lower end can be closed to fully enclose the battery holding structure and the ornamental decorations within the storage compartment. The open lower end can be opened by removing the removable bottom closure. In some instances, the open lower end can include a threaded portion that corresponds with a threaded portion on the removable bottom closure. The removable bottom closure can be removed by unscrewing the removable bottom closure from the open lower end and attached by screwing the removable bottom closure to the open lower end. In some instances, the open lower end can include an edge, clip, or other structure that corresponds with an edge, clip, or other corresponding structure on the removable bottom closure. The removable bottom closure can be removed by disengaging the removable bottom closure from the open lower end and attached by engaging the removable bottom closure with the open lower end. Other configurations for the storage compartment are possible, and the principles of the present invention are not limited to a particular configuration.

In one aspect of the present invention, the second portion of the beverage container (e.g., the storage compartment), can include an opening (e.g., hole) in its wall through which the ornamental decoration can pass. For example, a string light connected to a battery in the storage compartment can pass through the opening and wrap around the beverage container. The string light can be stored in the storage compartment when the string light is not in use. In some instances, the opening can be located on a portion of the removable bottom closure or other location on the beverage container. Other configurations for the storage compartment and other locations for the opening are possible, and the principles of the present invention are not limited to a particular configuration or a particular location.

In one aspect of the present invention, a user can decorate the beverage container with the ornamental decoration (stored in the storage compartment of the beverage container). For example, a user can remove the removable bottom closure from the bottom of the second portion of the beverage container (e.g., the storage compartment). The user can access the ornamental decoration within the storage compartment.

In this example, the storage compartment can include a battery-holding structure with a battery within the battery holding structure. The storage compartment can also include string lights connected to the battery holding structure. The user can pass the string lights through the opening in the storage compartment, and wrap the string lights around the outer wall of the beverage container. The user can secure one end of the string lights (the end opposite the end connected to the battery) to the outer wall of the beverage container.

The attachment of the ornamental decoration may be implemented via an attaching structure on the outer wall of the beverage container and/or the string lights. The attaching structure may include a portion associated with the outer wall and/or a portion associated with the string lights. Alternatively, the user may use an adhesive or adhesive device (e.g., tape) to attach the end of the string lights to the outer wall of the beverage container.

The user can turn on the string lights using a switch on the battery holding structure. The user can attach the removable bottom closure to the storage compartment of the beverage container to close the storage compartment of the beverage container.

When the user wants to remove the string lights, the user can open remove the removable bottom closure from the storage compartment of the beverage container to access the storage compartment. The user can turn off the string lights using the switch on the battery holding structure. The user can unwrap the string lights from around the beverage container and pull the string lights through the opening in the storage compartment to return the string lights to within the storage compartment. The user can attach the removable bottom closure to the storage compartment of the beverage container to close the storage compartment, storing the battery holding structure and the string lights within the storage compartment for later use. Other methods of use are possible, and the principles of the present invention are not limited to a particular method of use.

In one aspect of the present invention, the beverage container has one or a combination of various shapes. For example, the beverage container can have a cylindrical shape, which can be advantageous for applying an ornamental decoration, such as by wrapping a string light around the beverage container. Other shapes (e.g., round, spherical, tapered, conical, barrel, rectangular) and combinations of shapes can also be advantageous, and the principles of the present invention are not limited to a particular shape or a particular combination of shapes.

It should be appreciated that many other features, applications, aspects, and/or variations of the present invention will be apparent from the accompanying drawings and from the following detailed description. Additional and/or alternative implementations of the structures and methods described herein can be employed without departing from the principles of the present invention.

### BRIEF DESCRIPTION OF THE DRAWINGS

FIGS. 1A-1C illustrate views of an example beverage container with a storage compartment, according to various embodiments of the present invention.

FIGS. 2A-2C illustrate views of an example beverage container with a storage compartment, according to various embodiments of the present invention.

FIG. 3A illustrates a view of an example storage compartment in a beverage container, according to various embodiments of the present invention.

FIGS. 3B-3C illustrate views of an example removable bottom closure, according to various embodiments of the present invention.

FIG. 4 illustrates a view of an example beverage container with a storage compartment, according to various embodiments of the present invention.

The figures depict various embodiments of the present invention for purposes of illustration only, wherein the figures use like reference numerals to identify like elements. It should be noted that the features illustrated in the figures are not necessarily drawn to scale, and features of one embodiment may be employed with other embodiments as one skilled in the art would recognize, even if not expressly stated herein. Descriptions of well-known components may be omitted so as to not unnecessarily obscure the embodiments of the present invention. One skilled in the art will readily recognize from the following discussion that alternative embodiments of the structures and methods illustrated in the figures can be employed without departing from the principles of the present invention described herein.

### DETAILED DESCRIPTION

As background, beverage containers, such as tumblers, are growingly increasingly popular among consumers. For example, some consumers enjoy using beverage containers as a way to reduce use of disposable cups. Some consumers enjoy using beverage containers to keep their hot beverages hot. Some beverage containers come with additional features that improve their utility. For example, some beverage containers come with lids that help protect against spills.

Under conventional approaches, beverage containers are generically manufactured without designs. That is, beverage containers are manufactured without options to decorate or design the beverage containers. Because beverage containers are manufactured without options to decorate or design them, decorating or designing a beverage container is accomplished through individual effort of a purchaser or user. However, decorating or designing a beverage container through individual effort faces various limitations and challenges. For example, a beverage container typically has no options for storing or holding ornamental decorations. Thus, any ornamental decorations applied to the beverage container through individual effort is unlikely to be durable or sturdy. Furthermore, attempting to apply an ornamental decoration to a beverage container with no options for storing or holding the ornamental decoration may cause damage to the beverage container and compromise its structure. Thus, conventional approaches are deficient with regard to decorating or designing beverage containers.

The present invention provides for an improved approach that addresses the deficiencies arising from conventional approaches. The present invention provides for a beverage container with a storage compartment in the base of the beverage container to store an ornamental decoration. The beverage container can include a container body with a first portion and a second portion. The first portion of the container body can include a beverage holding chamber. The second portion of the container body can include the storage compartment. The first portion (e.g., the beverage holding chamber) and the second portion (e.g., storage compartment) of the container body can be separated by an interior wall in the container body. In some instances, the container body can include an attaching structure (e.g., clip, fastener, clasp) to which the ornamental decoration can be attached. The beverage container can include a removable bottom closure that can be disengaged (e.g., removed) or engaged (e.g., attached) to the storage compartment. By removing the removable bottom closure, the storage compartment, and the ornamental decoration stored therein, can be accessed. By attaching the removable bottom closure, the ornamental decoration can be stored in the storage compartment. The removable bottom closure, when attached to the storage compartment, can serve as a base of the beverage container. In some instances, the storage compartment can include an opening (e.g., hole) in their wall through which the ornamental decoration can be passed. For example, the ornamental decoration can be a battery powered string light (or a set of battery powered string lights) that can be connected to a battery in the storage compartment, passed through the opening, and wrapped around the beverage container. In some instances, the storage compartment can include a battery holding structure to hold a battery for battery powered ornamental decorations. In some cases, the battery holding structure can be attached to a wall of the storage compartment, such as the interior wall separating the storage compartment and the beverage holding chamber, such that the battery holding structure is stored within the storage compartment. In some cases, the battery holding structure can be attached to an inner portion of the removable bottom closure such that, when the removable bottom closure is attached to the storage compartment, the battery holding structure is positioned within the storage compartment.

For example, the present invention can provide for a beverage container with battery powered string lights (or a set of battery powered string lights) that a user can use to decorate the beverage container. In this example, the storage compartment of the beverage container can include a battery-holding structure with a battery to power the battery powered string lights. The storage compartment can include the battery powered string lights connected to the battery via the battery-holding structure. To decorate the beverage container, the user can open the storage compartment by removing the removable bottom closure from the beverage container. Upon removing the removable bottom closure from the beverage container, the user can access the battery powered string lights stored within the storage compartment. The user can decorate the beverage container with the battery powered string lights by threading the battery powered string lights through an opening in a wall of the storage compartment, wrapping the battery powered string lights around the beverage container, and attaching the end of the battery powered string lights to the beverage container, for example, with an adhesive. In this example, the user can turn on the battery powered string lights with a switch on the battery holding structure. The user can close the storage compartment by attaching the removable bottom closure to the beverage container. Continuing this example, the user can also undecorate the beverage container. The user can open the storage compartment by removing the removable bottom closure from the beverage container. The user can turn off the battery powered string lights using the switch on the battery holding structure in the storage compartment. The user can remove the end of the battery powered string lights from the beverage container, unwrap the battery powered string lights from around the beverage container, and pull the battery powered string lights through the opening in the wall of the storage compartment. The battery powered string lights can be stored in the storage compartment. The user can close the storage compartment by attaching the removable bottom closure to the beverage container, and the battery powered string lights can be stored for later use. As illustrated in this example, the beverage container is readily decorated and undecorated as the ornamental decoration (e.g., battery powered string lights) are stored in the storage compartment and ready for use by the user. Furthermore, the beverage container is decorated without individual modifications to the beverage container by the user, which may compromise the structure of the beverage container. Further details regarding the present invention are provided below.

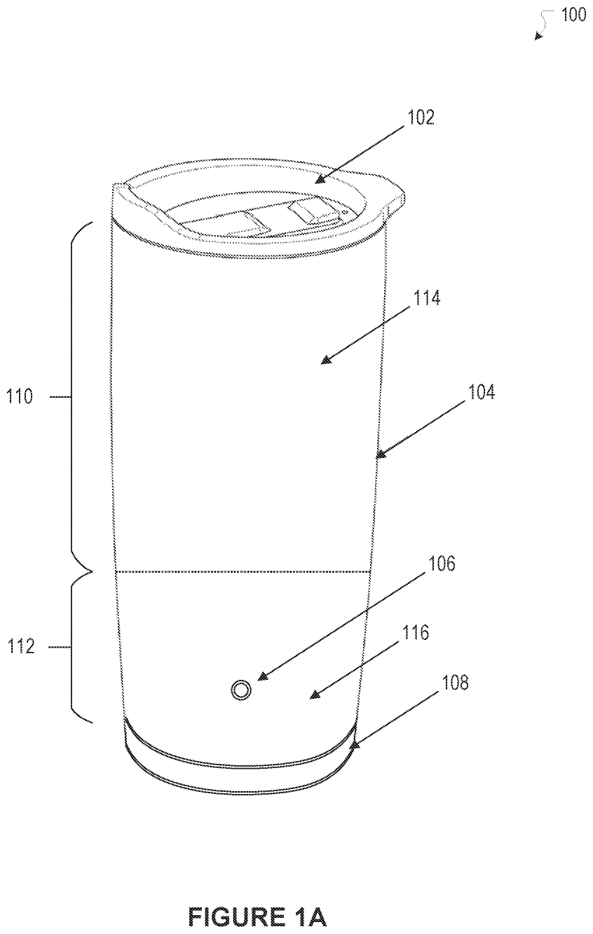

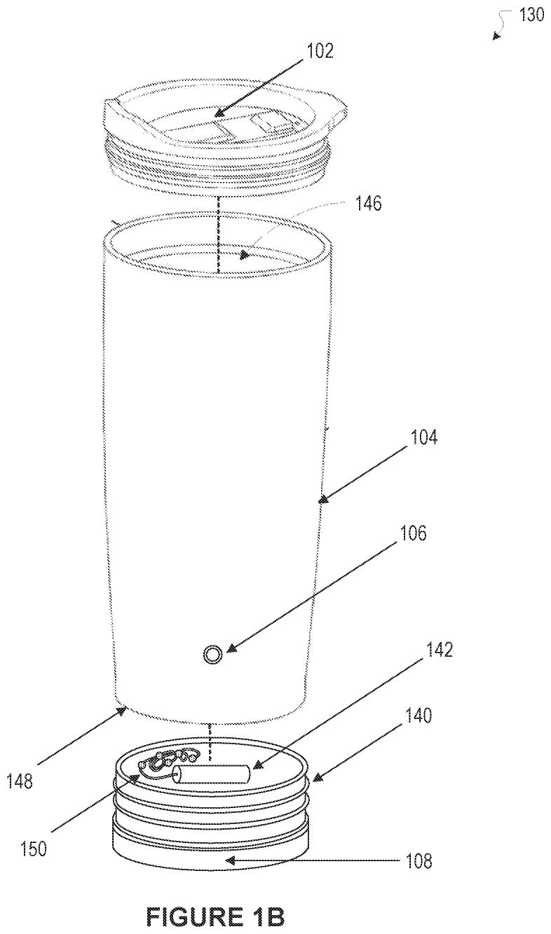

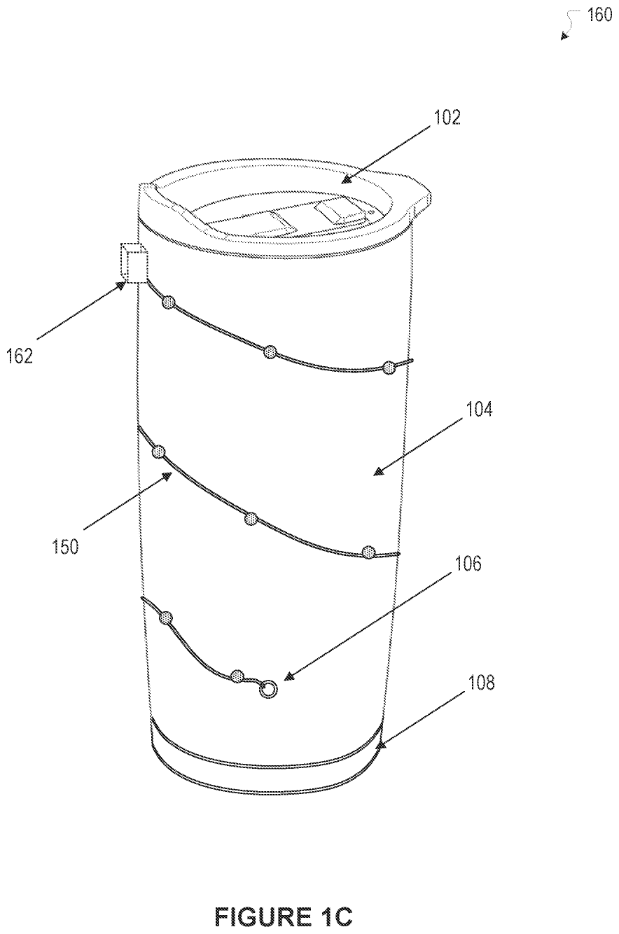

FIGS. 1A-1C illustrate views of an example beverage container with a storage compartment, according to various embodiments of the present invention. The views illustrated herein are depicted in simplified form to highlight features of the present invention. Description relating to one view of the example beverage container may not be reiterated for the other views to avoid repetition rather than to exclude features.

FIG. 1A illustrates a perspective view 100 of a beverage container 104. The beverage container 104 may have a removable lid 102. The removable lid 102 can seal the beverage container 104 when engaged with the beverage container 104. The beverage container 104 has a container body with a first portion 110 and a second portion 112. The first portion 110 can include a beverage holding chamber 114. The beverage holding chamber 114 can include an opening at an upper end through which a beverage (e.g., liquid) can be accessed. The second portion 112 can include a storage compartment 116. The storage compartment can be configured to enable storage of an ornamental decoration, such as a set of string lights, therein. The storage compartment 116 includes an opening 106 (e.g., through which an ornamental decoration in the storage compartment can be passed). The beverage container 104 includes a removable bottom closure 108. The removable bottom closure 108 can be removed and attached to the storage compartment 116 to provide access to the storage compartment 116. As illustrated in FIG. 1A, the opening 106 is located on a portion of a wall of the storage compartment 116. In this example, the opening 106 is a circular hole. Here, the location and shape of the opening 106 can be advantageous for a string light, or other string-like ornamental decoration (e.g., ribbon, cord, lace) to pass through the opening 106. The string light can be fed through the opening 106 from within the storage compartment 116 to decorate the beverage container 104, and the string light can be smoothly pulled through the opening 106 into the storage compartment 116 to undecorate the beverage container 104.

It should be understood the present invention is not limited to a particular location, a particular shape, or a particular size for the opening 106. The present invention provides for openings at various locations, in various shapes, and in various sizes. For example, the opening 106 can be located lower or higher in the storage compartment 116 of the beverage container 104. In some instances, the opening 106 can be located on or in the removable bottom closure 108. For example, the opening 106 can be located on a side of the removable bottom closure 108, which can allow an ornamental decoration, such as a string light, to wrap around the beverage container 104 from a location near the bottom of the beverage container 104. Various shapes for the opening 106 can accommodate different ornamental decorations. For example, the opening 106 can be rectangular shaped to accommodate a ribbon or other flat string ornamental decoration. Various sizes for the opening 106 can accommodate different ornamental decorations. For example, the opening 106 can be larger or smaller to accommodate larger or smaller string lights. Many variations are possible.

Furthermore, it should be understood the present invention is not limited to a particular number of openings. The present invention provides for beverage containers with multiple openings and, in some instances, no openings. For example, the beverage container 104 can include two or more openings to accommodate two or more decorations (e.g., string lights) that are passed through respective openings and wrap around the beverage container 104. In some instances, the beverage container 104 does not include an opening. For example, the ornamental decoration can be a battery powered music device that plays music from within the storage compartment 116. The music device can play music that is audible when played from within the storage compartment 116. Many variations are possible.

As illustrated in FIG. 1A, the beverage container 104 has a tapered cylindrical shape with the first portion 110 of the beverage container wider than the second portion 112 of the beverage container. Here, the tapered cylindrical shape can advantageously provide a larger capacity in the beverage holding chamber 114 in the first portion 110 while being able to fit into a standard cup holder. It should be understood the present invention is not limited to a particular shape or combination of shapes. For example, the beverage container 104 can have a variety of other shapes (e.g., round, spherical, tapered, conical, barrel, rectangular) or a combination of shapes. Many variations are possible.

FIG. 1B illustrates an exploded view 130 of a beverage container 104. The beverage container 104 in this example can illustrate the beverage container 104 of FIG. 1A and components of the beverage container 104. As illustrated in FIG. 1B, the beverage container 104 includes a removable lid 102. In this example, the removable lid 102 has a threaded portion that allows the removable lid 102 to be rotated to be engaged (e.g., attached) to the beverage container 104. The beverage container 104 includes a threaded portion 146 that corresponds with the threaded portion of the removable lid 102 such that the removable lid 102 can be attached to and disengaged (e.g., removed) from the beverage container 104 by rotating on and rotating off the removable lid 102. As illustrated in FIG. 1B, the beverage container 104 includes an opening 106. In this example, the opening 106 is a circular hole on a wall of the storage compartment within the beverage container 104. As illustrated in FIG. 1B, the beverage container 104 includes a removable bottom closure 108. In this example, the removable bottom closure 108 has a threaded portion 140 that corresponds with a threaded portion 148 on the beverage container 104. The removable bottom closure 108 can be removed from and attached to the beverage container 104 by rotating off and rotating on the removable bottom closure 108. Rotating off and removing the removable bottom closure 108 provides access to a battery 142 and string lights 150. The battery 142 and the string lights 150 can be the ornamental decoration for the beverage container 104 in this example. The battery 142 can be contained in a battery holding structure (not shown) attached to the removable bottom closure 108. With the removable bottom closure 108 removed from the beverage container 104, a user can pass the string lights 150 from within the storage compartment of the beverage container 104, through the opening 106, and around the beverage container 104 to decorate the beverage container 104. The removable bottom closure 108 can be rotated on and attached to the beverage container 104 to contain the battery 142 in the storage compartment of the beverage container 104 while the beverage container 104 is decorated with the string lights 150.

The present invention provides for various configurations of removable bottom closures. For example, the removable bottom closure 108 can include an outer wall with a first portion configured to engage an open lower end of the storage compartment of the beverage container 104. The removable bottom closure 108 can engage the open lower end of the storage compartment of the beverage container 104 such that the first portion of the outer wall is enclosed within the storage compartment of the beverage container 104. The first portion of the outer wall can include the threaded portion 140 that engages with the threaded portion 148 on the beverage container 104 when the removable bottom closure 108 is engaged with the open lower end of the storage compartment of the beverage container 104. The removable bottom closure 108 can include a second portion integral with the first portion. The outer diameter of the second portion can be greater than the outer diameter of the first portion. The second portion can form an exposed lip extending below the outer wall of the beverage container 104 when the removable bottom closure 108 is engaged with the open lower end of the storage compartment of the beverage container 104. The second portion can include ridges for engagement by a user to engage and disengage the removable bottom closure 108. Many variations are possible.

While the removable bottom closure 108 is illustrated in this example with a threaded portion 140, it should be understood the present invention is not limited to removable bottom closures with threaded portions. For example, the removable bottom closure 108 can have a clip or other engagement structure that corresponds with a corresponding clip or other corresponding engagement structure on the beverage container 104. The removable bottom closure 108 can be removed from the beverage container 104 by disengaging the clip or the engagement structure from the corresponding clip or the corresponding engagement structure on the beverage container 104. The removable bottom closure 108 can be attached to the beverage container 104 by engaging the clip or the engagement structure with the corresponding clip or the corresponding engagement structure on the beverage container 104. In some instances, the removable bottom closure 108 can be connected to the beverage container 104 via a friction fit. For example, the removable bottom closure 108 and the lower end of the beverage container 104 where the removable bottom closure 108 would make contact with the beverage container 104 when attached can both have a material that results in a high friction coefficient (e.g., rubber, aluminum, textured plastic). Many variations are possible.

As illustrated in FIG. 1B, the outer surface of the removable bottom closure 108 is flush with the outer surface of the beverage container 104. This can advantageously give the beverage container 104 a smooth appearance and help hide the storage compartment of the beverage container 104. It should be understood the present invention is not limited to a particular shape or size of removable bottom closures. For example, the removable bottom closure 108 can be larger (e.g., larger width, larger radius) than the beverage container 104 with an inner portion that corresponds with the beverage container 104 such that the removable bottom closure can be attached to the beverage container 104. A larger removable bottom closure can provide for increased stability when the beverage container 104 is set on a surface. In some instances, the removable bottom closure 108 can be smaller (e.g., smaller width, smaller radius) than the beverage container 104 such that the removable bottom closure fits within the walls of the beverage container 104 when the removable bottom closure 108 is attached to the beverage container 104. A smaller removable bottom closure can appear hidden when the beverage container 104 is set on a surface, which may be visually appealing. Many variations are possible.

FIG. 1C illustrates a perspective view 160 of a beverage container 104. The beverage container 104 in this example can illustrate the beverage container 104 of FIG. 1A and the beverage container 104 of FIG. 1B decorated with string lights 150. As illustrated in FIG. 1C, the beverage container 104 includes a removable lid 102. The beverage container 104 includes a removable bottom closure 108 that is attached to the beverage container 104, closing a storage compartment in the beverage container 104. The beverage container 104 includes an opening 106 through which the string lights 150 is pulled through from the storage compartment in the beverage container 104. The string lights 150 is wrapped around the beverage container 104 from the opening 106 to where the string lights 150 is attached near the top of the beverage container 104. The string lights 150 can be attached via an attaching structure 162. In some instances, the attaching structure 162 can be a hook, a clip, a fastener, a clasp, a latch, a hook and loop fastener, or other attaching mechanism. For example, the attaching structure 162 can be a hook and loop fastener that attaches to a corresponding hook and loop fastener on the end of the string lights 150. In some instances, the string lights 150 can be attached via an adhesive. As illustrated in FIG. 1C, a user can decorate the beverage container 104 with an ornamental decoration, which in this example is the string lights 150, stored in a storage compartment. To decorate the beverage container 104, the user opened the storage compartment by removing the removable bottom closure 108. The user pulled the string lights 150 stored in the storage compartment through the opening 106, wrapped the string lights 150 around the beverage container 104, and attached the end of the string lights 150 to the beverage container 104. The user then closed the storage compartment by attaching the removable bottom closure 108. As illustrated in this example, the user is able to easily decorate the beverage container 104 with the string lights 150 without making individual alterations to the beverage container 104, which may potentially damage or compromise the beverage container 104.

It should be understood the present invention is not limited to a particular ornamental decoration, such as the string lights 150. The present invention provides for various ornamental decorations. For example, the beverage container 104 can be decorated with a ribbon that wraps around the beverage container 104 from the opening 106 to an attaching structure on the beverage container 104. As another example, the beverage container 104 can be decorated with multiple string lights that wrap around the beverage container 104 from multiple respective openings to multiple respective attaching structures on the beverage container 104. As illustrated in these examples, the present invention provides for beverage containers with various ornamental decorations, including ornamental decorations that are battery powered (e.g., string lights) and ornamental decorations that are not battery powered (e.g., ribbons). The present invention also provides for beverage containers with multiple ornamental decorations (e.g., multiple string lights). Many variations are possible.

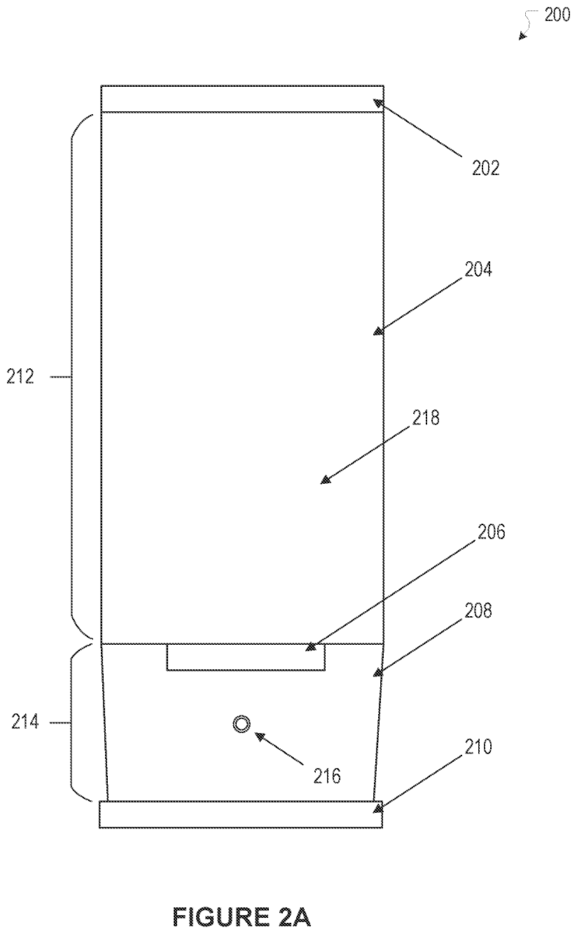

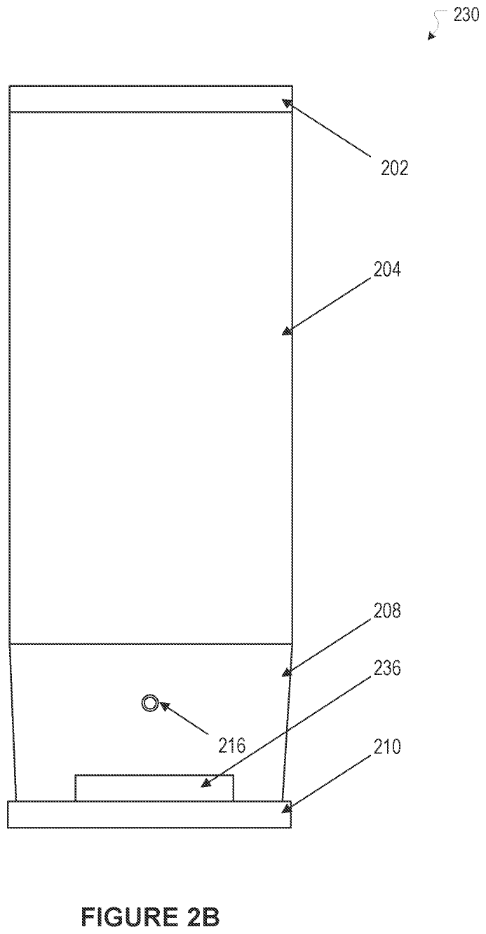

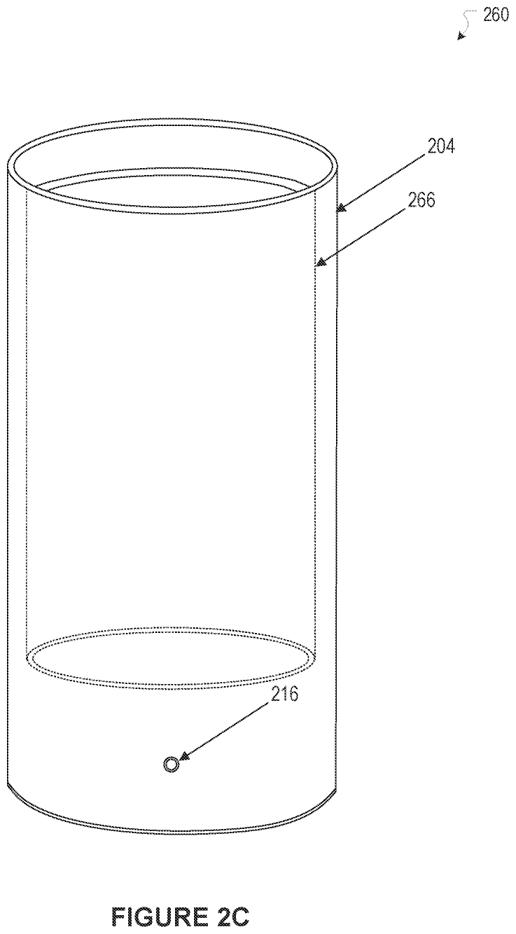

FIGS. 2A-2C illustrate views of an example beverage container with a storage compartment, according to various embodiments of the present invention. The views illustrated herein are depicted in simplified form to highlight features of the present invention. Description relating to one view of the example beverage container may not be reiterated for the other views to avoid repetition rather than to exclude features.

FIG. 2A illustrates a side view 200 of a beverage container 204. The beverage container 204 has a detachable lid 202. The beverage container 204 has a container body with a first portion 212 and a second portion 214. The first portion 212 can include a beverage holding chamber 218. The second portion 214 can include a storage compartment 208. The storage compartment 208 includes a battery holding structure 206 attached to an internal wall within the beverage container 204 separating the beverage holding chamber 218 and the storage compartment 208. The storage compartment 208 has an opening 216 through which an ornamental decoration can pass. The beverage container 204 includes a removable bottom closure 210. The removable bottom closure 210 can be removed to provide access to the storage compartment 208 and the battery holding structure 206 within the storage compartment 208. The battery holding structure 206 is capable of holding a battery. The battery holding structure 206 can connect to a battery powered ornamental decoration (not shown), such as string lights. The battery holding structure 206 can include a switch (not shown) to turn on or turn off the battery powered ornamental decoration.

As illustrated in FIG. 2A, in this example, the battery holding structure 206 is attached to the internal wall within the beverage container 204 separating the beverage holding chamber 218 and the storage compartment 208. To access the battery holding structure 206, a user can remove the removable bottom closure 210. Having the battery holding structure 206 attached to a wall within the beverage container 204 can be advantageous in that the battery holding structure 206 can be accessed without disturbing the battery powered ornamental decoration connected to the battery holding structure 206. For example, string lights may be wrapped around the beverage container 204 and connected to the battery holding structure 206. Removing the removable bottom closure 210 and opening the storage compartment 208 to access the battery holding structure 206, for example, to undecorate the beverage container 204, does not pull on the string lights.

It should be understood the present invention is not limited to the battery holding structure 206 attached to the internal wall within the beverage container 204 separating the beverage holding chamber 218 and the storage compartment 208. For example, the battery holding structure 206 can be attached to the inner side of a side wall within the storage compartment 208 of the beverage container 204. Many variations are possible.

FIG. 2B illustrates a side view 230 of a beverage container 204. The beverage container 204 has a detachable lid 202. The beverage container 204 can include a storage compartment 208. The storage compartment 208 includes a battery holding structure 236 attached to an inner side of a removable bottom closure 210. The beverage container 204 and the storage compartment 208 included therein has an opening 216 through which an ornamental decoration can pass. The removable bottom closure 210 can be removed to provide access to the storage compartment 208 and the battery holding structure 236 attached to the removable bottom closure 210. The battery holding structure 206 can be capable of holding a battery. The battery holding structure 236 can connect to a battery powered ornamental decoration (not shown), such as string lights. The battery holding structure 236 can include a switch (not shown) to turn on or turn off the battery powered ornamental decoration.

As illustrated in FIG. 2B, in this example, the battery holding structure 236 is attached to the inner side of the removable bottom closure 210. To access the battery holding structure 236, a user can remove the removable bottom closure 210. Having the battery holding structure 236 attached to the inner side of the removable bottom closure 210 can be advantageous in that the battery holding structure 236 can be easily accessed when the removable bottom closure 210 is removed. For example, a user who wants to access the battery holding structure 236, for example, to replace the battery, can remove the removable bottom closure 210 to easily access the battery holding structure 236.

It should be understood that the present invention provides for beverage containers with battery holding structures in various locations. For example, as illustrated in FIG. 2A, a battery holding structure can be attached to a wall of the storage compartment of a beverage container. As illustrated in FIG. 2B, a battery holding structure can be attached to an inner side of the removable bottom closure of a beverage container. Many variations are possible.

FIG. 2C illustrates a perspective view 260 of a beverage container 204. The beverage container 204 in this example can illustrate the beverage container 204 of FIG. 2A or the beverage container 204 of FIG. 2B. As illustrated in FIG. 2C, the beverage container 204 has a beverage holding chamber 266. In this example, the beverage holding chamber 266 can be double-walled. That is, the beverage holding chamber 266 can include an interior wall and an exterior wall separated by a gap with at least a partial vacuum therein. The interior wall between the beverage holding chamber 266 and the storage compartment of the beverage container 204 can be double-walled. That is, the interior wall can include two walls separated by a gap with at least a partial vacuum therein. The beverage container 204 includes an opening 216 through which an ornamental decoration can pass. As illustrated in this example, the opening 216 is located on the beverage container 204 such that it does not compromise the structure of the beverage holding chamber 266. Thus, the beverage container 204 simultaneously allows for an ornamental decoration to be stored within the beverage container 204 and for a beverage to be stored in the beverage holding chamber 266 of the beverage container 204.

It should be understood the present invention is not limited to having a double-walled beverage holding chamber. For example, the present invention provides for a beverage container with a single-walled beverage holding chamber. Many variations are possible.

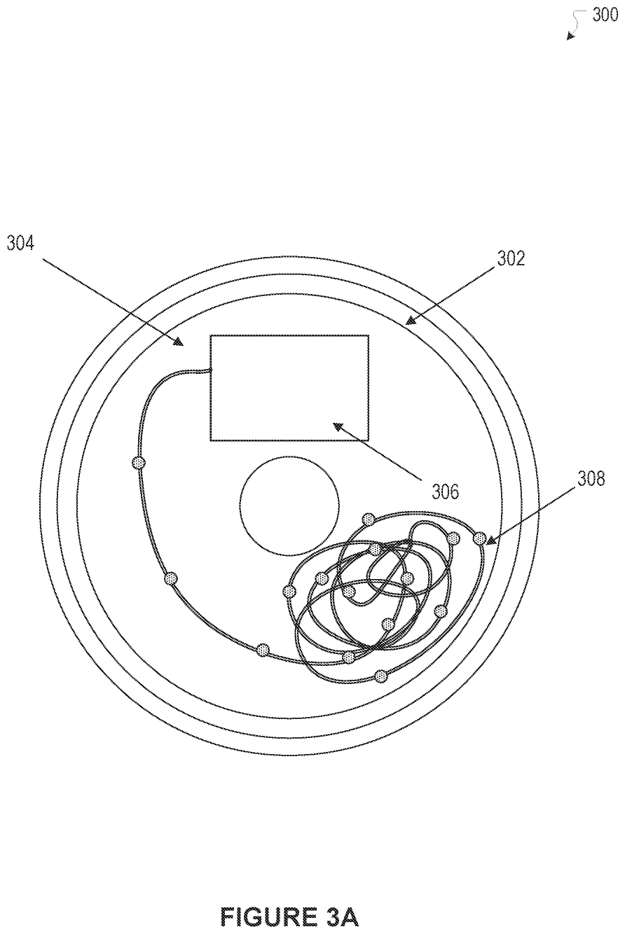

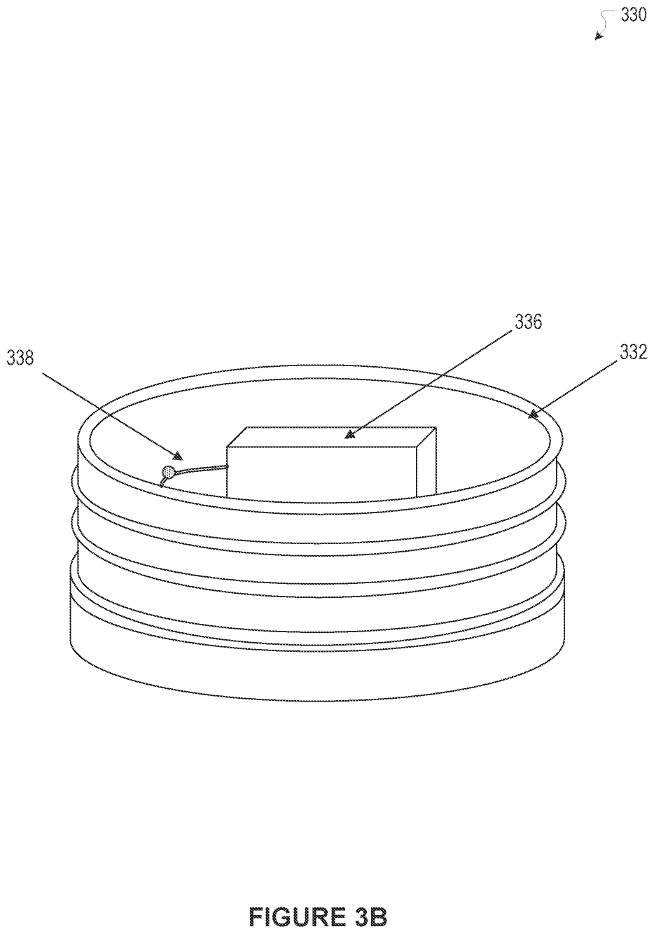

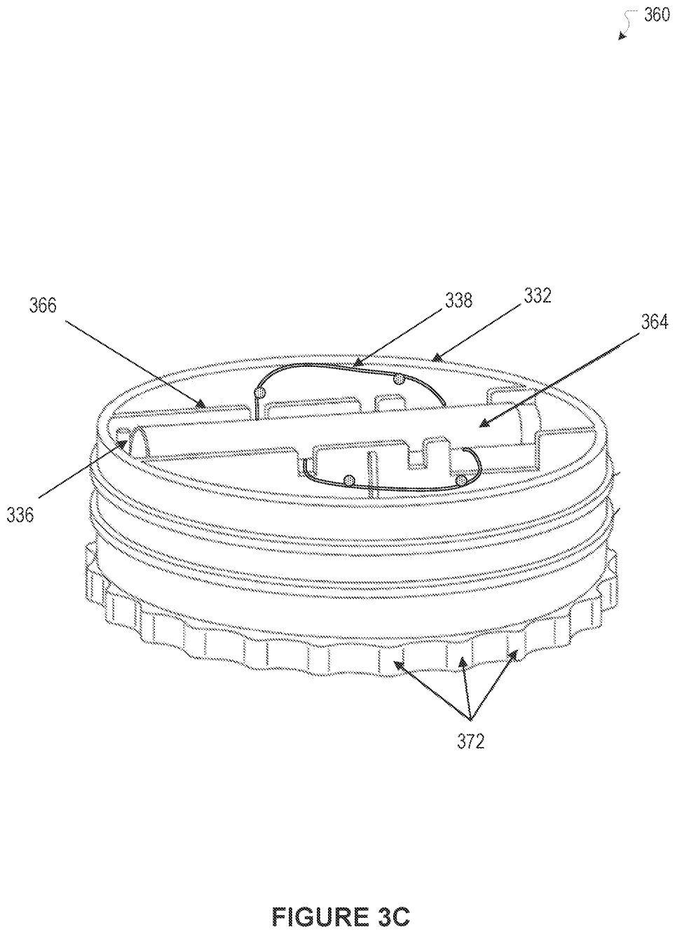

FIGS. 3A-3C illustrate views of an example storage compartment in a beverage container and an example removable bottom closure, according to various embodiments of the present invention. The views illustrated herein are depicted in simplified form to highlight features of the present invention. Description relating to one view of the may not be reiterated for other views to avoid repetition rather than to exclude features.

FIG. 3A illustrates a view 300 of a storage compartment 302 in a beverage container. As illustrated in this example, the storage compartment 302 stores a battery holding structure 306 and string lights 308 connected to the battery holding structure 306. The battery holding structure 306 and the string lights 308 can be fixedly attached or removably attached. The battery holding structure 306 can be attached to an interior wall 304 separating the storage compartment 302 from a beverage holding chamber (not shown) in the beverage container. The battery holding structure 306 can be attached via various means. For example, the battery holding structure 306 can be attached to the interior wall 304 via a clip, a latch, a screw, an adhesive, and the like. In some instances, the battery holding structure 306 and the string lights 308 can be provided unattached to the beverage container. For example, the battery holding structure 306 and the string lights 308 can be packaged in a bag stored within the storage compartment 302 and delivered with the beverage container. Upon delivery, a user can remove the battery holding structure 306 and the string lights 308 from the bag and attach the battery holding structure 306 to the interior wall 304 via an adhesive, which can also be provided with the beverage container.

FIG. 3B illustrates a view 330 of a removable bottom closure 332. As illustrated in this example, the removable bottom closure 332 has a battery holding structure 336 attached to an inner portion of the removable bottom closure 332. The battery holding structure 336 is connected to string lights 338, which can be stored in the removable bottom closure 332. The battery holding structure 336 and the string lights 338 can be fixedly attached or removably attached. The battery holding structure 336 can be attached via various means. For example, the battery holding structure 336 can be attached to the inner portion of the removable bottom closure 332 via a clip, a latch, a screw, an adhesive, and the like. As illustrated in in FIG. 3A and FIG. 3B, the present invention provides for a battery holding structure in various locations in a beverage container, such as on an internal wall of the beverage container as illustrated in FIG. 3A or on an inner portion of a removable bottom closure of the beverage container as illustrated in FIG. 3B. Many variations are possible.

FIG. 3C illustrates a view 360 of a removable bottom closure 332. As illustrated in this example, the removable bottom closure 332 has a battery holding structure 336 to hold a battery 364. In some instances, the battery holding structure 336 can be included in a battery enclosure (not shown) attached to the removable bottom closure 332. The battery holding structure 336 can be configured to removably secure the battery 364 within the battery holding structure 336 on the removable bottom closure 332. The battery holding structure 336 can include one or more sub-structures (e.g., channels, grooves) to hold one or more batteries in relatively fixed positions within the battery holding structure 336. The one or more sub-structures can be configured to receive and hold the one or more batteries. The one or more sub-structures can include one or more protrusions (e.g., bumps, springs) configured to retain the one or more batteries within the one or more sub-structures. In this example, the battery holding structure 336 includes one channel to hold the battery 364. The battery holding structure 336 is connected to string lights 338. The battery holding structure 336 and the string lights 338 can be fixedly attached or removably attached. The string lights 338 are stored using the storage structure 366. In this example, the string lights 338 are wrapped around the storage structure 366 to facilitate organized storage of the string lights 338. The storage structure 366 can advantageously facilitate easy storage of the string lights 338, or other ornamental decoration, when the string lights 338 are not being used to decorate. It should be understood that the features described in this example are applicable to a battery holding structure and ornamental decoration stored in a storage compartment of a beverage container. For example, the storage compartment of the beverage container can include a storage structure, such as the storage structure 366 to facilitate storage of an ornamental decoration in the storage compartment. Many variations are possible.

As illustrated in FIG. 3C, the removable bottom closure 332 has a ridged edge 372 along the bottom of the removable bottom closure 332. The ridged edge 372 can advantageously facilitate easy removal and attachment of the removable bottom closure 332. It should be understood that the present invention provides for various configurations of the removable bottom closure. For example, a removable bottom closure can have a textured edge, a rubber edge, and the like. Many variations are possible.

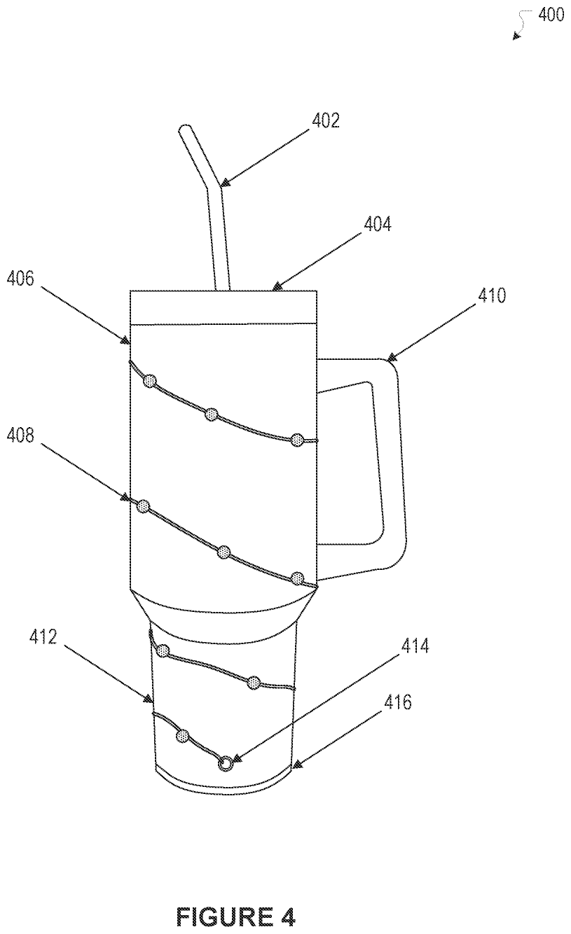

FIG. 4 illustrates a view 400 of a beverage container 406. In this example, the beverage container 406 includes a detachable lid 404, a straw 402, and a handle 410. The beverage container 406 has a mixed shape with a bottom tapered portion 412. The beverage container 406 includes a removable bottom closure 416 attached to the bottom of the beverage container 406. The beverage container 406 is decorated with a string light 408 that is wrapped around the beverage container 406 from an opening 414 to an attaching structure on the beverage container 406. As illustrated in this example, the present invention provides for a beverage container with various configurations. It should be noted that the present invention provides for beverage containers of various materials and with various features. For example, the beverage container can be made of stainless steel and be double-walled. Many variations are possible.

In one aspect of the present invention, the beverage container is made of one or a combination of various materials. For example, the beverage container can be made of stainless steel. Stainless steel can be an advantageous because stainless steel is durable and typically does not react to beverages, unlike other metals. Other materials (e.g., plastic, silicon, glass, acrylic, aluminum) and combinations of materials can also be advantageous, and the principles of the present invention are not limited to a particular material or a particular combination of materials.

In one aspect of the present invention, the beverage container has one or more structural features. For example, the beverage container can be double-walled. The double-walled feature of the beverage container can be advantageous for preventing condensation from forming on the outer surface of the beverage container, which may damage an ornamental decoration on the beverage container, and for insulating beverages in the beverage container. The double-walled feature of the beverage container can encompass the sides and the bottom of the first portion (e.g., beverage holding chamber) of the beverage container. Other structural features (e.g., single-walled feature) and combinations of features can also be advantageous, and the principles of the present invention are not limited to a particular feature or a particular combination of features.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the various embodiments of the present invention are intended to be illustrative, but not limiting, of the scope of the present invention, which is set forth in the following claims.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

Reference in this specification to “one embodiment,” “an embodiment,” “other embodiments,” “another embodiment,” “in various embodiments,” or the like means that a particular feature, design, structure, or characteristic described in connection with the embodiment is included in at least one embodiment of the present invention. The appearances of, for example, the phrases “according to an embodiment,” “in one embodiment,” “in an embodiment,” “in various embodiments,” or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

What is claimed is:

1. A beverage container comprising:
a container body comprising:
a first portion comprising a beverage holding chamber;
a second portion comprising a storage compartment;
a removable bottom closure for the storage compartment, the storage compartment comprising a battery holding structure and configured to enable storage of a set of string lights therein, the set of string lights having a first end connected or connectable to the battery holding structure and a second end; and
an opening in a portion of the storage compartment through which the second end of the set of string lights can pass.

2. The beverage container of claim 1, comprising an attachment mechanism located at or near an upper end of the container body and configured to attach the second end of the set of string lights to the container body.

3. The beverage container of claim 1, wherein the removable bottom closure comprises a threaded portion that engages with a corresponding threaded portion on the storage compartment.

4. The beverage container of claim 1, wherein the removable bottom closure comprises the battery holding structure.

5. The beverage container of claim 1, further comprising an internal wall that separates the first portion of the container body and the second portion of the container body.

6. The beverage container of claim 5, wherein the battery holding structure is attached to a portion of the internal wall within the storage compartment.

7. The beverage container of claim 5, wherein the beverage holding chamber is double-walled and the internal wall is double-walled.

8. The beverage container of claim 1, wherein the removable bottom closure comprises an outer wall with a first portion configured to engage an open lower end of the storage compartment, wherein the first portion of the outer wall is enclosed within the storage compartment when the removable bottom closure is engaged with the open lower end of the storage compartment.

9. The beverage container of claim 8, wherein the outer wall further comprises a second portion integral with the first portion, wherein an outer diameter of the second portion is greater than an outer diameter of the first portion, and wherein the second portion forms an exposed lip when the removable bottom closure is engaged with the open lower end of the storage compartment.

10. The beverage container of claim 1, further comprising a removable lid.

11. The beverage container of claim 1, further comprising a handle attachable to the container body.

12. The beverage container of claim 1, wherein the container body comprises stainless steel.

13. A method for applying an ornamental decoration to a beverage container comprising:
disengaging a removable bottom closure from the beverage container;
accessing the ornamental decoration in a storage compartment of the beverage container;
passing the ornamental decoration through an opening the storage compartment;
wrapping the ornamental decoration around the beverage container; and
attaching an end of the ornamental decoration to the beverage container.

14. The method of claim 13, wherein the attaching the end of the ornamental decoration to the beverage container comprises attaching the end of the ornamental decoration with an adhesive.

15. The method of claim 13, wherein the attaching the end of the ornamental decoration to the beverage container comprises attaching the end of the ornamental decoration to an attaching structure on the beverage container.
